(19) United States
(12) Patent Application Publication
(10) Pub. No.: US 2018/0150148 A1
(43) Pub. Date: May 31, 2018

(54) HANDHELD INTERACTIVE DEVICE AND PROJECTION INTERACTION METHOD THEREFOR

(71) Applicant: IView DISPLAYS (SHENZHEN) COMPANY LTD., ShenZhen (CN)

(72) Inventors: Steve YEUNG, ShenZhen (CN); Zhiqiang GAO, ShenZhen (CN); Qingyun LIN, ShenZhen (CN); Jianbo XU, ShenZhen (CN)

(21) Appl. No.: 15/572,378

(22) PCT Filed: Nov. 5, 2015
(86) PCT No.: PCT/CN2015/093891

§ 371 Date: Nov. 7, 2017

(30) Foreign Application Priority Data
Jun. 30, 2015 (CN) 2015103900942

(51) Int. Cl. G06F 3/038; G06F 3/0346; G06F 3/01; G06F 3/0354; G06T 19/00

(52) U.S. Cl. CPC G06F 3/0383; G06F 3/0346; G06F 3/011; G06T 7/73; G06T 19/006; G06F 2203/0384; G06F 3/03547

(57) ABSTRACT

The invention provides a handheld interactive device, comprising: a projection module, being configured to project initial virtual projection information onto real projection space; a camera module, being configured to acquire image data information of virtual reality projection space, establish a coordinate transformation model, and acquire coordinate transformation parameter information; a sensing control module, being configured to acquire relative position information of the handheld interactive device and initial real projection space; a CPU, being configured to receive, process and analyze data information from the camera module, the projection module, and the sensing control module according to image vision algorithm, and based on analysis result, to control the projection module to project corresponding virtual projection information; a wireless communication module; and a memory module, the projection module, camera module, sensing control module, wireless communication module, and memory module each are electrically connected to and controlled by the CPU.

### FIELD OF THE INVENTION

The invention relates to the field of virtual reality, and more particularly to a handheld interactive device of an integrated projector and a projection interaction method using the same.

### BACKGROUND OF THE INVENTION

With the rapid development of electronic integration and computer technology, the interactive handheld devices and multimedia applications integrating multiple functions emerge endlessly, and user demand for large screen and virtual reality human-computer interaction has become increasingly urgent. In recent years, the interactive projection has become an increasingly popular multimedia display platform; using computer vision technology and projection display technology, the users can interact between themselves or surrounding three-dimensional space and the virtual scene of the projection area, to create a dynamic and interactive experience. Interactive projection has the characteristics of nature, conciseness and directness, so it has a wide application prospect in fields such as virtual reality, human-computer interaction, and visual surveillance. The handheld interactive devices, a product integrating projectors, computers, and cameras, etc., exhibit both common projection functions and special projection functions, thus enriching the user experience, and a user can use them anytime anywhere.

However, in the process of virtual reality interaction using existing handheld interactive devices, the real-time interactive effect is adversely affected by the factors such as the angle and location changes of the handheld interactive devices, as well as the changes of the projection environment, so it is difficult to accurately and freely perform the virtual reality human-computer interaction anytime anywhere, leading to poor use experience.

### SUMMARY OF THE INVENTION

In view of the above-described problems, it is one objective of the invention to provide a handheld interactive device and a projection interaction method using the same. In the present disclosure, a projection module, a camera module, a sensing control module, a CPU, a wireless communication module, and a memory module are combined to form the handheld interactive device which has small size and light weight. In use, the handheld interactive device is placed on the hand of a user, the user uses the hand to control the position and angle change of the handheld interactive device to interact, thus accurately and freely performing the virtual reality interaction anytime anywhere, free of the influence such as the angle and location changes of the handheld interactive devices, as well as the changes of the projection environment, exhibiting powerful functionality and entertainment, and enhancing the immersive feeling and visual enjoyment.

To achieve the above objective, the following technical solutions are adopted.

A handheld interactive device, the device comprising: a projection module, being configured to project initial virtual projection information onto real projection space; a camera module, being configured to acquire image data information of virtual reality projection space, establish a coordinate transformation model, and acquire coordinate transformation parameter information; a sensing control module, being configured to acquire relative position information of the handheld interactive device and initial real projection space; a CPU, being configured to receive, process and analyze data information from the camera module, the projection module, and the sensing control module according to image vision algorithm, and based on analysis result, to control the projection module to project corresponding virtual projection information; a wireless communication module; and a memory module; where, the projection module, camera module, sensing control module, wireless communication module, and the memory module each are electrically connected to and controlled by the CPU.

In a class of this embodiment, the CPU is Android or Linux or IOS.

In a class of this embodiment, the device further comprises: a rechargeable battery and wireless charging model; and an audio-frequency circuit and loudspeaker. The arrangement of the rechargeable battery ensures the use and charge of the handheld interactive device are not limited to the wired power supply, so that the handheld interactive device can work freely anytime anywhere. The handheld interactive device has multiple function and entertainment, so it is power-consuming. The wireless charging module can supplement the electric quantity of the rechargeable battery in time effectively, thus greatly increasing the endurance of the handheld interactive device.

In a class of this embodiment, the sensing control module comprises a direction sensor, an acceleration sensor, an angular velocity sensor, and/or a gravity sensor, and/or an infrared sensor.

In a class of this embodiment, the camera module is capable of acquiring a full projection image of the projection module.

In a class of this embodiment, the device further comprises a touch sensor, which may be a touch screen.

In a class of this embodiment, the wireless communication module comprises a Bluetooth communicator and/or a WiFi communicator, which can conveniently and quickly receive the data information sent by other electronic equipment.

In a class of this embodiment, a light source of the projection module is an LED light source, which is small-sized and can meet the requirement for embedded handheld interactive devices.

In another respect, the present disclosure further provides a projection interaction method using a handheld interactive device, the method comprising:

(S1): projecting, by a projection module, initial virtual projection information onto real projection space;

(S2): acquiring, by a camera module, image data information of virtual reality projection space;

(S3): real-time controlling, by a user, the handheld interactive device to move according to virtual reality space images;

(S4): real-time acquiring, by a sensing control module, relative position information of the handheld interactive device and image information on virtual projection space;

(S5): receiving, processing and analyzing, by a CPU, data information from the camera module, the projection module, and the sensing control module according to image vision algorithm; and

(S6): controlling, by the CPU and based on analysis result, the projection module to project corresponding virtual projection information, to achieve virtual reality interaction.

In a class of this embodiment, (S1) further comprises:

(S11): initiating all work modules of the handheld interactive device;

(S12): acquiring, by the camera module, image data information of initial real projection space;

(S13): acquiring, by the sensing control module, relative position information of the handheld interactive device and the initial real projection space;

(S14): receiving and analyzing, by the CPU, data information from the camera module, the projection module, and the sensing control module, establishing a model relationship between the handheld interactive device and projection space, and initializing parameters of the projection module to allow the projection module to project normally; and

(S15): projecting, by the projection module, the initial virtual projection information onto the real projection space.

In a class of this embodiment, image data information of the real projection space is three-dimensional information of the real projection space, which comprises position information, color information of the real projection space, and other information capable of determining a position, bump, texture, color, brightness of the real projection space.

In a class of this embodiment, the position information of the handheld interactive device comprises angle posture of the handheld interactive device and a relative position distance between the handheld interactive device and the real projection space.

Advantages of the handheld interactive device and the projection interaction method using the same of the present disclosure are summarized as follows. The present disclosure provides a handheld interactive device and a projection interaction method using the same. The handheld interactive device comprises a projection module which is configured to project virtual image, a camera module which is configured to acquire the image data information of virtual reality projection space, a sensing control module which is configured to real-time acquire relative position information of the handheld interactive device, and a CPU which is configured to receive, process and analyze data information from the camera module and the sensing control module. The projection module, the camera module, and the sensing control module are all electrically connected to and controlled by the CPU. The projection interaction method combines the projection module, the camera module, the sensing control module and the CPU, the handheld interactive device can act according to the images of the virtual reality projection space, change the angle posture thereof and the relative position relationship with the projection space, to achieve the virtual reality interaction anytime anywhere, exhibiting powerful functionality and entertainment, and enhancing the immersive feeling and visual enjoyment.

### BRIEF DESCRIPTION OF THE DRAWINGS

FIG. 1 is a schematic diagram of a handheld interactive device in accordance with one embodiment of the invention;

FIG. 2 is a flow chart of a projection interaction method using a handheld interactive device in accordance with one embodiment of the invention;

FIG. 3 is a specific flow chart of a projection interaction method using a handheld interactive device in accordance with one embodiment of the invention; and

FIG. 4 is another specific flow chart of a projection interaction method using a handheld interactive device in accordance with one embodiment of the invention.

### DETAILED DESCRIPTION OF THE EMBODIMENTS

To further illustrate the invention, experiments detailing a handheld interactive device and a projection interaction method using the same are described below.

FIG. 1 is a schematic diagram of a handheld interactive device in accordance with one embodiment of the invention. As shown in FIG. 1, the handheld interactive device 100 comprises: a projection module 102, a camera module 103, a sensing control module 104, a wireless communication module 105, a memory module 106, and a CPU 101; the projection module 102, the camera module 103, the sensing control module 104, wireless communication module 105, and the memory module 105 6each are electrically connected to and controlled by the CPU 101.

The camera module 103 is configured to acquire image data information of virtual reality projection space; the sensing control module 104 is configured to acquire the position information of the handheld interactive device and the image information on the virtual projection space; the CPU 101 is configured to receive, process and analyze data information from the camera module 103 and the sensing control module 104 according to image vision algorithm, and based on analysis result, to control the projection module 102 to project corresponding virtual projection information; the memory module 106 is configured to store the data information generated in the usage process, so as to facilitate the CPU 101 to compare and analyze the data, or facilitate the data search and analysis.

Preferably, the camera module 103 comprises an acquisition device, which may be a conventional camera lamp; the projection module 102 comprises a projection device, which may be a LCOS mini projector or DLP mini projector with an LED light source, which is small-sized and suitable for handholding.

Preferably, the CPU 101 is Android or Linux or IOS system; the system can employ systems of existing portable devices, or exclusive processing systems.

The handheld interactive device 100 further comprises: a rechargeable battery and wireless charging model, and an audio-frequency circuit and loudspeaker. The arrangement of the rechargeable battery ensures the use and charge of the handheld interactive device is not limited to the wired power supply, so that the handheld interactive device can work freely anytime anywhere. The handheld interactive device is rich in function and entertainment, so it is power-consuming. The wireless charging module can supplement the electric quantity of the rechargeable battery in time and effectively, thus greatly increasing the endurance of the handheld interactive device 100; so the charging battery makes the use of the handheld interactive device more convenient. The arrangement of the audio-frequency circuit and loudspeaker can achieve the audio playing when the users hold the handheld interactive device to interact, thus enhancing the user experience. In addition, the handheld interactive device 100 comprises the wireless communication module 105 and the audio-frequency circuit, so the users can use mobile phones or tablet computers and other mobile terminals to obtain audio and video information within a certain distance, thus monitoring the situation of infants out of sight.

The sensing control module 104 comprises a direction sensor, an acceleration sensor, an angular velocity sensor, and/or a gravity sensor, and/or an infrared sensor. When the users hold and control the handheld interactive device 100 to move, the angular velocity sensor can sense the angular speed of the three axis around the handheld interactive device, and calculate the angle of rotation of the handheld device in real time according to its rotation time, and transmit the information to the CPU, the direction sensor can absolutely align the direction aligned by the handheld interactive device, thereby further reducing the calculation error of the angle sensor; the acceleration sensor can calculate the placement state of the handheld interactive devices based on combined multiple sets of data, such as being flat or tilt, tilt angle, motion state, etc. In addition, the handheld interactive device comprising an infrared sensor has the function of automatic focusing, which can be applied to the field of security and protection. The direction sensor can absolutely align the direction aligned by the handheld interactive device, and in combination with the data transmitted back from the gravity sensor, the parameters comprising the placement state of the handheld interactive device 100, that is, being flat or tilt, tilt angle, motion state, can be calculated. Based on the parameters, the CPU 101 may calculate the direction aligned by the handheld interactive device 100, and then project the image previously stored in the memory module 106 corresponding to the direction. Optionally, the angle sensor can first preliminarily orientate the handheld interactive device 100, and then the CPU 101 performs calculations according to the data transmitted from the direction sensor and the gravity sensor, to correct the error of the angle sensor.

The camera module 103 is capable of acquiring a full projection image of the projection module 102.

The handheld interactive device 100 further comprises a touch sensor, which may be a touch screen.

The wireless communication module 105 comprises a Bluetooth communicator and/or a WiFi communicator, which can conveniently and quickly receive the data information sent by other electronic equipment.

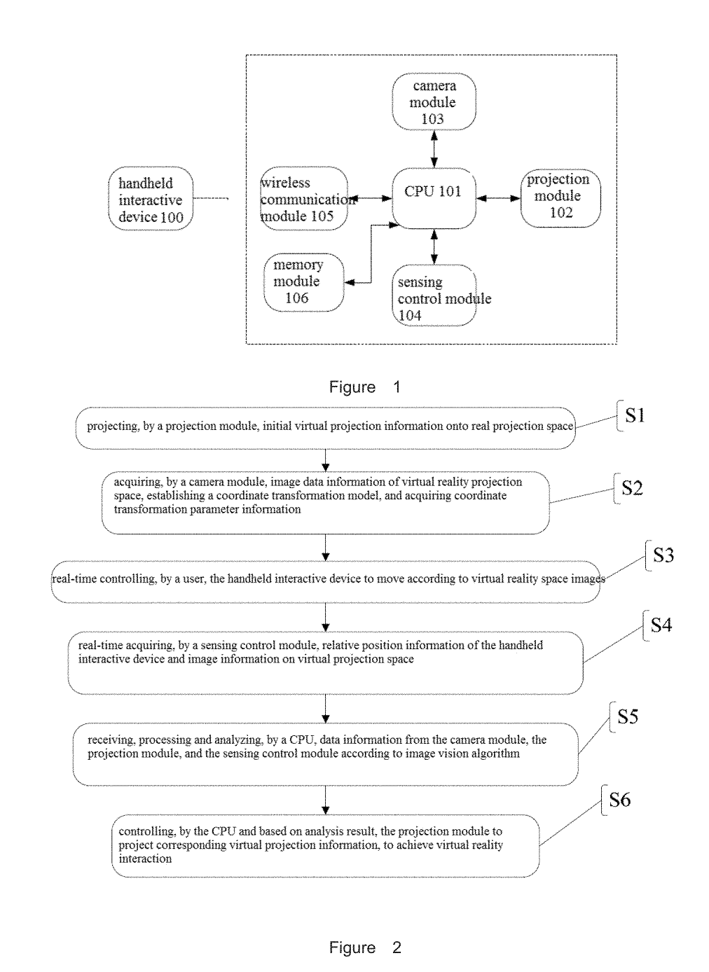

FIG. 2 is a flow chart of a projection interaction method using the handheld interactive device, the method comprising:

(S1): projecting, by a projection module, initial virtual projection information onto real projection space;

(S2): acquiring, by a camera module, image data information of virtual reality projection space, establishing a coordinate transformation model, and acquiring coordinate transformation parameter information;

(S3): real-time controlling, by a user, the handheld interactive device to move according to virtual reality space images;

(S4): real-time acquiring, by a sensing control module, relative position information of the handheld interactive device and image information on virtual projection space;

(S5): receiving, processing and analyzing, by a CPU, data information from the camera module, the projection module, and the sensing control module according to image vision algorithm; and

(S6): controlling, by the CPU and based on analysis result, the projection module to project corresponding virtual projection information, to achieve virtual reality interaction.

In a preferred embodiment of the present disclosure, in step (S1), the camera module acquires the initial virtual projection information, and the projection module projects the initial virtual projection image on the real projection space; in step (S2), the camera module selects feature points from the image data information of the virtual reality projection space, real time acquires information comprising the relative position information of the feature points of the virtual reality projection space, processes the acquired images and extracts selected feature points therefrom, acquires the position information of the selected feature points on the projection space, transmits the information to the CPU, establishes a coordinate transformation model and acquires coordinate transformation parameter information according to the image position information of the feature points on the imaging plane of the camera module and the position information on the projection space; in step (S3), the users real time control the handheld interactive device to move according to the images of the virtual reality space; in step (S4), the sensing control module acquires the relative position information of the handheld interactive device and the virtual reality projection space, and the acquisition device real time acquires the information comprising the image position information of the action points of the handheld interactive device on the virtual reality projection space;

in step (S5), the CPU receives and analyzes the information transmitted from the camera module and the sensing control module, based on the position information of the selected feature points on the virtual reality space and the initial relative position information of the handheld interactive device and the virtual reality space, processes and analyzes the data information from the camera module and the sensing control module according to image vision algorithm, to obtain the virtual position information of the handheld interactive device on the virtual image; the acquired position information is processed according to the corresponding transformation relation algorithm of the coordinate system, to obtain corresponding execution position information; in step (S6), based on analysis result, the CPU controls the projection module to project corresponding virtual projection information according to the virtual position information of the handheld interactive device on the virtual image, executes corresponding control on the corresponding positions on the original data input interface, thus achieving the virtual reality interaction.

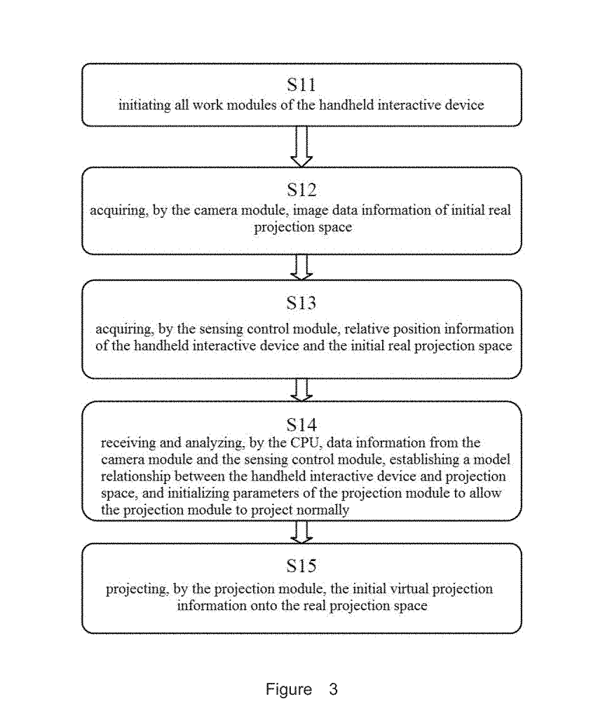

As shown in FIG. 3, in a preferred embodiment of the present disclosure, (S1) further comprises:

(S11): initiating all work modules of the handheld interactive device;

(S12): acquiring, by the camera module, image data information of initial real projection space;

(S13): acquiring, by the sensing control module, relative position information of the handheld interactive device and the initial real projection space;

(S14): receiving and analyzing, by the CPU, data information from the camera module and the sensing control module, establishing a model relationship between the handheld interactive device and projection space, and initializing parameters of the projection module to allow the projection module to project normally; and

(S15): projecting, by the projection module, the initial virtual projection information onto the real projection space.

In a preferred embodiment of the present disclosure, in step (S12), the acquisition device acquires the image data information of the initial reality projection space, and selects feature points from the image data information of the initial reality projection space, processes the acquired images and extracts selected feature points therefrom, acquires the position information of the selected feature points on the projection space, transmits the information to the CPU; in step (S13), the sensing control module acquires the initial relative position information of the handheld interactive device and the initial reality projection space, and transmits the information to the CPU; in step (S14), the CPU receives and analyzes the information transmitted from the camera module and the sensing control module, and based on the position information of the selected feature points on the initial reality space and the initial relative position information of the handheld interactive device and the initial reality projection space, establishes an initial model relationship of the handheld interactive device and the projection space, thus acquiring the parameter information for initializing the projection module; in step (S15), the projection module projects the initialized virtual projection information on the real projection space.

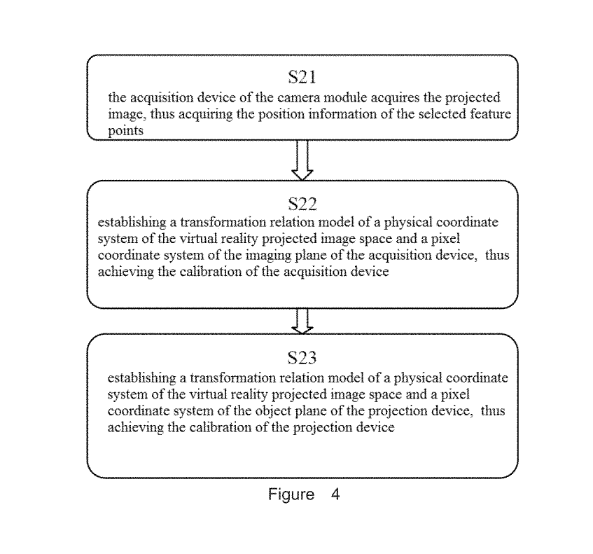

As shown in FIG. 4, in a preferred embodiment of the present disclosure, (S2) further comprises:

(S21) the acquisition device of the camera module acquires the projected image, and selects feature points from the known projected image of the initial reality projection space, processes the acquired images and extracts selected feature points therefrom, thus acquiring the position information of the selected feature points;

(S22) establishing a transformation relation model of a physical coordinate system of the virtual reality projected image space and a pixel coordinate system of the imaging plane of the acquisition device, based on the position information of the selected feature points on the virtual reality projected image space, acquiring the internal and external parameter information of the acquisition device, thus achieving the calibration of the acquisition device;

(S23) establishing a transformation relation model of a physical coordinate system of the virtual reality projected image space and a pixel coordinate system of the object plane of the projection device, based on the position information of the selected feature points on the virtual reality projected image space, acquiring the internal and external parameter information of the projection device, thus achieving the calibration of the projection device.

In a preferred embodiment of the present disclosure, in (S22), establishing a transformation relation model of a physical coordinate system of the virtual reality projected image space and a pixel coordinate system of the imaging plane of the acquisition device is implemented as follows: operate the coordinate of the physical coordinate system of the virtual reality projected image space and the rotation matrix and translation matrix of the initial external parameters on the imaging plane of the acquisition device, thus transforming the physical coordinate system of the virtual reality projected image space into the pixel coordinate system of the imaging plane of the acquisition device; in combination with ideal pinhole imaging model, operate the coordinate system on the imaging plane of the acquisition device and the internal parameters of the acquisition device, thus transforming the lens coordinate system of the acquisition device into the pixel coordinate system of the imaging plane of the acquisition device. It is well-known that, an ideal pinhole imaging model is a geometric model used to describe the correspondence between any point in space and its imaging points on an image. These geometric model parameters are the calibration parameters of the acquisition device.

Preferably, the transformation relation model of the physical coordinate system of the virtual reality projected image space and the pixel coordinate system of the imaging plane of the acquisition device in (S22) is as follows:

$$[ \begin{matrix}w \hat{x} \\ w \hat{y} \\ w\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}R & P\end{matrix} ] [ \begin{matrix}X \\ Y \\ Z \\ 1\end{matrix} ]$$

where, (X,Y,Z) represents the physical coordinate of points of the virtual reality projected image space, X, Y and Z represent a horizontal coordinate value, a vertical coordinate value, and a radial coordinate value, respectively; (\hat{x},ŷ) represents a pixel coordinate of points on the imaging plane of the acquisition device, and \hat{x} and ŷ respectively represent a column pixel coordinate and a line pixel coordinate of points on the imaging plane of the acquisition device; w represents a depth of field parameter of imaging of the acquisition device, and w=Z; cₓ and c_{y} respectively represent a horizontal offset and a vertical offset of points on the imaging plane of the acquisition device; fₓ and f_{y} respectively represent a horizontal focal length parameter and a vertical focal length parameter of points on the imaging plane of the acquisition device; R=[\vec{r}ₓ,\vec{r}_{y},\vec{r}_{z}] represents a rotation matrix of points on the imaging plane of the acquisition device; P=[pₓ,p_{y},p_{z}]^{T} represents a translation matrix of imaging of the acquisition device; the internal parameters of the acquisition device comprise: the horizontal offset cₓ and the vertical offset c_{y} of points on the imaging plane of the acquisition device, and the horizontal focal length parameter fₓ and the vertical focal length parameter fₓ of points on the imaging plane of the acquisition device; the external parameters of the acquisition device comprise: the rotation matrix R=[\vec{r}ₓ,\vec{r}_{y},\vec{r}_{z}] and the translation matrix P=[pₓ,p_{y},p_{z}]^{T}.

In a preferred embodiment of the present disclosure, in (S23), establishing a transformation relation model of a physical coordinate system of the virtual reality projected image space and a pixel coordinate system of the object plane of the projection device is implemented as follows: operate the coordinate of the physical coordinate system of the virtual reality projected image space and the rotation matrix and translation matrix of the external parameters of the projection device, thus transforming the physical coordinate system of the virtual reality projected image space into the projection lens coordinate system of the projection device; in combination with ideal pinhole imaging model, operate the projection lens coordinate system of the projection device and the internal parameters of the projection device, thus transforming the projection lens coordinate system of the projection device into the pixel coordinate system of the points of the object plane of the projection device. It is well-known that, an ideal pinhole imaging model is a geometric model used to describe the correspondence between any point in space and its imaging points on an image. These geometric model parameters are the calibration parameters of the projection device.

Preferably, the transformation relation model of the physical coordinate system of the virtual reality projected image space and the pixel coordinate system of the object plane of the projection device in (S23) is as follows:

$$s [ \begin{matrix}u \\ v \\ 1\end{matrix} ] = [ \begin{matrix}{f}_{x}^{′} & 0 & {c}_{x}^{′} \\ 0 & {f}_{y}^{′} & {c}_{y}^{′} \\ 0 & 0 & 1\end{matrix} ] [ \begin{matrix}{R}^{′} & {P}^{′}\end{matrix} ] [ \begin{matrix}X \\ Y \\ Z \\ 1\end{matrix} ]$$

where, (X,Y,Z) represents the physical coordinate of points of the virtual reality projected image space, X, Y and Z represent a horizontal coordinate value, a vertical coordinate value, and a radial coordinate value, respectively; (u,v) represents a pixel coordinate of points on the imaging plane of the projection device; s represents a scaling factor; fₓ′ and f_{y}′ respectively represent a horizontal focal length parameter and a vertical focal length parameter of points on the object plane of the projection device; R′=[\vec{r}ₓ′,\vec{r}_{y}′,\vec{r}_{z}′] represents a rotation matrix of points on the imaging plane of the acquisition device; P′=[pₓ′,p_{y}′,p_{z}′]^{T} represents a translation matrix of imaging of the acquisition device; the internal parameters of the projection device comprise: the horizontal offset cₓ′ and the vertical offset c_{y}′ of points on the object plane of the projection device, and the horizontal focal length parameter fₓ′ and the vertical focal length parameter f_{y}′ of points on the object plane of the projection device; the external parameters of the projection device comprise: the rotation matrix R′=[\vec{r}ₓ′,\vec{r}_{y}′,\vec{r}_{z}′] and the translation matrix P′=[pₓ′,p_{y}′,p_{z}′]^{T}.

In a preferred embodiment of the present disclosure, step (S5) further comprises: (S51) according to the information acquired by the acquisition device and comprising the position information of the virtual reality projected image of the action points of the handheld interactive device on the virtual reality projection space, determining the real time external parameter information of the acquisition device and the projection device, acquiring the coordinate of the action points of the handheld interactive device in the pixel coordinate system of the imaging plane of the acquisition device, and according to the transformation relation model of the physical coordinate system of the virtual reality projected image space and the pixel coordinate system of the imaging plane of the acquisition device obtained in step (S22), calculating the coordinate of the action points of the handheld interactive device in the physical coordinate system of the virtual reality projected image space; (S52) according to the transformation relation model of the physical coordinate system of the virtual reality projected image space and the pixel coordinate system of the object plane of the projection device obtained in (S23), as well as the coordinate of the action points of the handheld interactive device in the physical coordinate system of the virtual reality projected image space obtained in (S51) and the real time external parameter information of the acquisition device and the projection device, calculating the pixel coordinate of the action points of the handheld interactive device in the object plane of the projection device; (S53) according to the pixel coordinate of the action points of the handheld interactive device in the object plane of the projection device, calibrating the real time action points of the action points of the handheld interactive device in the object plane of the projection device corresponding to the projection picture.

In a preferred embodiment of the present disclosure, step (S6) further comprises: (S61) the system simulates to control the touch screen, according to the real time action points of the action points of the handheld interactive device in the object plane of the projection device corresponding to the projection picture determined in step (S53), determining the position information of the real action points in the systematic input device, and after receiving the control information corresponding to the position information, the systematic application program executes the input control on the corresponding position; (S62) based on the analysis result of the data information of the sensing control module, the CPU acquires the virtual position motion information of the handheld interactive device on the virtual image, and controls the projection device to project corresponding virtual images according to the virtual position information of the handheld interactive device in the virtual image.

Specifically, the image data information of the real projection space is three-dimensional information of the real projection space, which comprises position information, color information of the real projection space, and other information capable of determining a position, bump, texture, color, brightness of the real projection space. The position information of the handheld interactive device comprises the angle posture of the handheld interactive device with regard to the real projection space and a relative position distance between the handheld interactive device and the real projection space.

The handheld interactive device and the projection interaction method combine the projection module, the camera module, the sensing control module and the CPU, the handheld interactive device can act according to the images of the virtual reality projection space, change the angle posture and the relative position relationship with the projection space, to achieve the virtual reality interaction anytime anywhere, exhibiting powerful functionality and entertainment, and enhancing the immersive feeling and visual enjoyment. For example, based on the handheld interactive device and the projection interaction method of the present disclosure, the users can perform shoot games and smart home development, and so on, in a certain three-dimensional space. The handheld interactive device can act according to the projection space changes acquired by the camera module, the sensing control module acquires the motion data information, the CPU controls the projection module to project corresponding projection images, thus achieving the combination of virtuality and reality, and providing a feeling as on the scene.

The handheld interactive device and the projection interaction method can be applied to various portable devices, including but not limited to mobile phones, IPAD, laptops, netbooks, can also be installed in a dedicated terminal device. The projection module is built in the portable devices, can employ a device adapted for projection such as projection lens, can employ a projection device of a conventional portable device, or an individually-set special projection device. The camera module is built inside the portable device, configured to gather images, can employ data image acquisition devices such as camera of conventional portable devices, or an individually-set special camera device.

The handheld interactive device and the projection interaction method can be applied in real life, for example, the handheld interactive device is installed in a mobile terminal device such as mobile phones, first, pre-acquire the surrounding environment, record the objects that correspond to each of the positions in the actual space, or initialize the object images in each direction of the initial real space, store the acquired or initialized images in the device, and store in the interactive projection device. In use, the users hold the handheld interactive device to move in different directions, meanwhile, the inductors such as direction sensors or gyroscopes mounted in the interactive projection device sense the moving direction of the interactive projection device. Thus, based on the real moving direction, the images corresponding to any direction and pre-stored in the interactive projection device are projected, facilitating the users to search or perform other operations.

When the handheld interactive device is disposed in a mobile terminal such as mobile phones, firstly, the projected virtual images are initialized and stored in the interactive projection device. In use, the users hold the interactive projection device and project the virtual images prestored in the interactive projection device, the photographers can make themselves stay in the projected virtual image, thus achieving the combination of the human with the virtual scenery image.

When the handheld interactive device is disposed in a mobile terminal such as mobile phones, firstly, some specific projection images and audio data are preset in the CPU, the camera of mobile phones captures the surrounding environment images, the phone microphone senses the tones of the outside environment, and these data are transmitted to the CPU. Based on the data information, the CPU calculates and acquires feedback corresponding to the current environment, for example, the CPU controls the mobile phones to automatically adjust the tempo, tone, or play corresponding audio data according to the data result, or control the projector of the mobile phones to automatically project the image, color and so on that adapt to the current environment, so as to achieve the function of regulating the atmosphere.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

1. A handheld interactive device, the device comprising:
a projection module, being configured to project initial virtual projection information onto real projection space;
a camera module, being configured to acquire image data information of virtual reality projection space, establish a coordinate transformation model, and acquire coordinate transformation parameter information;
a sensing control module, being configured to acquire relative position information of the handheld interactive device and initial real projection space;
a CPU, being configured to receive, process and analyze data information from the camera module, the projection module, and the sensing control module according to image vision algorithm, and based on analysis result, to control the projection module to project corresponding virtual projection information;
a wireless communication module; and
a memory module;
wherein, the projection module, the camera module, the sensing control module, the wireless communication module, and the memory module each are electrically connected to and controlled by the CPU.

2. The device of claim 1, further comprising: a rechargeable battery and wireless charging model; and an audio-frequency circuit and loudspeaker.

3. The device of claim 1, wherein the sensing control module comprises a direction sensor, an acceleration sensor, an angular velocity sensor, and/or a gravity sensor, and/or an infrared sensor.

4. The device of claim 1, wherein the camera module is capable of acquiring a full projection image of the projection module.

5. The device of claim 1, further comprising a touch sensor.

6. The device of claim 1, wherein the wireless communication module comprises a Bluetooth communicator and/or a WiFi communicator.

7. The device of claim 1, wherein a light source of the projection module is an LED light source.

8. A projection interaction method using a handheld interactive device, the method comprising:
(S1): projecting, by a projection module, initial virtual projection information onto real projection space;
(S2): acquiring, by a camera module, image data information of virtual reality projection space, establishing a coordinate transformation model, and acquiring coordinate transformation parameter information;
(S3): real-time controlling, by a user, the handheld interactive device to move according to virtual reality space images;
(S4): real-time acquiring, by a sensing control module, relative position information of the handheld interactive device and image information on virtual projection space;
(S5): receiving, processing and analyzing, by a CPU, data information from the camera module, the projection module, and the sensing control module according to image vision algorithm; and
(S6): controlling, by the CPU and based on analysis result, the projection module to project corresponding virtual projection information, to achieve virtual reality interaction.

9. The method of claim 8, wherein (S1) further comprises: (S11): initiating all work modules of the handheld interactive device; (S12): acquiring, by the camera module, image data information of initial real projection space; (S13): acquiring, by the sensing control module, relative position information of the handheld interactive device and the initial real projection space; (S14): receiving and analyzing, by the CPU, data information from the camera module, the projection module, and the sensing control module, establishing a model relationship between the handheld interactive device and projection space, and initializing parameters of the projection module to allow the projection module to project normally; and (S15): projecting, by the projection module, the initial virtual projection information onto the real projection space.

10. The method of claim 8, wherein image data information of the real projection space is three-dimensional information of the real projection space, which comprises position information, color information of the real projection space, and other information capable of determining a position, bump, texture, color, brightness of the real projection space.

11. The method of claim 10, wherein the position information of the handheld interactive device comprises angle posture of the handheld interactive device and a relative position distance between the handheld interactive device and the real projection space.

12. The method of claim 9, wherein image data information of the real projection space is three-dimensional information of the real projection space, which comprises position information, color information of the real projection space, and other information capable of determining a position, bump, texture, color, brightness of the real projection space.
